(19) United States
(12) Patent Application Publication
(10) Pub. No.: US 2020/0030763 A1
(43) Pub. Date: Jan. 30, 2020

(54) Disposable Bucket Liner for Mixing of Thermal Reactants

(71) Applicant: Stephen Jones, Houston, TX (US)

(72) Inventor: Stephen Jones, Houston, TX (US)

(21) Appl. No.: 16/046,874

(22) Filed: Jul. 26, 2018

(51) Int. Cl. B01F 15/00; B65D 25/16

(52) U.S. Cl. CPC B01F 15/00837; B65D 25/16

(57) ABSTRACT

A liner for a bucket which is thermally stable above the temperature of thermally reactants, where the liner is structurally stable and/or secured to the bucket in a manner that allows mixing of reactants or other viscous materials without twisting but is removable to allow reuse of the bucket for another task.

### BACKGROUND OF THE INVENTION

### Background of the Invention

This invention relates generally to a liner for a reusable bucket, and more particularly to a form fitted disposable plastic liner that slideably engages within a five-gallon bucket.

Reusable buckets are often used in construction for mixing chemicals prior to application. A long-standing problem among professionals and do-it-yourselfers has been the necessity of cleaning the containers after use. Because of their relative depth, buckets are particularly difficult to clean. As a solution, the use of liners allows a bucket to be reused with minimal cleaning by removing and replacing the liner.

Liners are a nice solution to many problems but can create additionally issues when it is necessary to mix/stir bucket contents. Power mixers, such as those commonly attached to a power drill, can cause a liner to twist, tear, and force contents out of the top of the bucket, creating messes. This is particularly true with viscous materials which resist the rotating forces. Additionally, liners are usually manufactured out of thin plastics which may soften, tear, melt, or otherwise degrade when a compound is exothermic.

### BRIEF DESCRIPTION OF THE DRAWINGS

FIG. 1 shows a liner in accordance with an exemplary embodiment of the invention.

FIG. 2 shows a liner with adhesives and protective strips in accordance with an exemplary embodiment of the invention.

FIGS. 3A and 3B illustrate insertion of a liner into a bucket in accordance with an exemplary embodiment of the invention.

### DETAILED DESCRIPTION OF THE PREFERRED EMBODIMENTS

This invention relates generally to a liner for a reusable bucket, and more particularly to a form fit disposable plastic liner that slideably engages within a standard five-gallon bucket and secures to the bucket for use in mixing chemicals which have an exothermic reaction. Exothermic reactions, such as the mixing of multi-part epoxy resin compounds used for floor finishes, can reach temperature in excess of 140° C. These temperatures soften and cause deformation in most plastic liners, and often complete degradation.

In the preferred embodiment, liners are fashioned polymers with high working temperatures such as, but not limited to: Polychlorotrifluoroethylene (PCTFE or PTFCE), with an upper working temperature range of 120° C.-150° C.; polyamide/imide (PAI), with an upper working temperature range of 200° C.-260° C.; and Polybenzimidazole (PBI), with an upper working temperature range of 260° C.-400° C.

The high working temperature of the material is defined as a temperature at which the material does not significantly soften or start to degrade. Degradation of plastics may be melting, softening to the point of detectable strength loss, or undergoing chemical changes such as crystalizing or beginning glass transition. One skilled in the arts would appreciate that different plastics may be used for the liners, depending on the expected temperature extremes of the thermal reaction.

In the preferred embodiment, liners are formed by injection molding. But one skilled in the arts would appreciate that liners could also be fashioned from sheet plastics, which are welded, glued, or otherwise mated together by joining a sheet into a cylinder and then welding a disk on one end to create a bottom.

In the preferred embodiment, the upper end of the cylindrical side wall is extended out radially to form a rim which is substantially the same size as the upper edge of the intended bucket. If the fit of the cylindrical side wall is flexible, but sized so it is unable to fold outward and back over itself to encapsulate the top edge of the intended bucket, then a plurality of small cuts, parallel to the cylindrical side wall's central axis may extend from the open end of the liner down toward the lower end, and would create a plurality of tabs around the top of the liner which could be folded over the bucket's top edge to create the upper rim of the liner.

In another embodiment, the cylindrical side wall may be flexible and elastic to allow it to fold out over the upper edge of the bucket. In this embodiment, the side wall is taller than the bucket's side wall, and the portion of the side wall that extends higher than the bucket's side wall and is provided to fold over takes the place of and is also referred to herein as the liner's rim.

To prevent twisting of the liner due to mixing actions and viscous contents, the liner is secured to the bucket. Even if the liner is rigid, exothermal reactions can cause the liner material to soften (though not to the point of strength loss), which could allow twisting of the liner. Therefore, it is desirable to secure the liner to the bucket to prevent repositioning during use.

This is accomplished by the use of non-structural adhesives, also referred to in industry as holding adhesives. Holding adhesives bind a liner to the bucket for use but are removable after use of the liner is complete. Holding adhesives can be applied to any external surface of the liner.

In the preferred embodiment adhesives are applied to the outside surface of the bottom of the liner and under the rim of the liner. No adhesives are applied to the side walls of the liner because these would make it more difficult to slide the liner into the bucket because the adhesives could pre-maturely attach to the inside wall of the bucket before the liner is fully seated inside of the bucket.

In the preferred embodiment, the first adhesive is applied in a ring on the outside surface of the bottom of the liner, near the circumference of the liner's bottom and covered with a protective strip. A second adhesive is applied to the under surface of the liner's rim and is covered by another protective strip.

To use the liner, the protective strip is removed from the bottom of the liner, and the liner is inserted into a bucket. It is pushed all the way in to the bucket, so the liner's bottom contacts the inner surface of the bucket's bottom, and pressure is applied to bind the adhesive on the bottom of the liner to the inside bottom of the bucket. Air is allowed to escape between the liner and the bucket, then the protective strip removed from the adhesive on the underside of the rim of the liner and the rim of the liner is pressed to the top edge of the bucket.

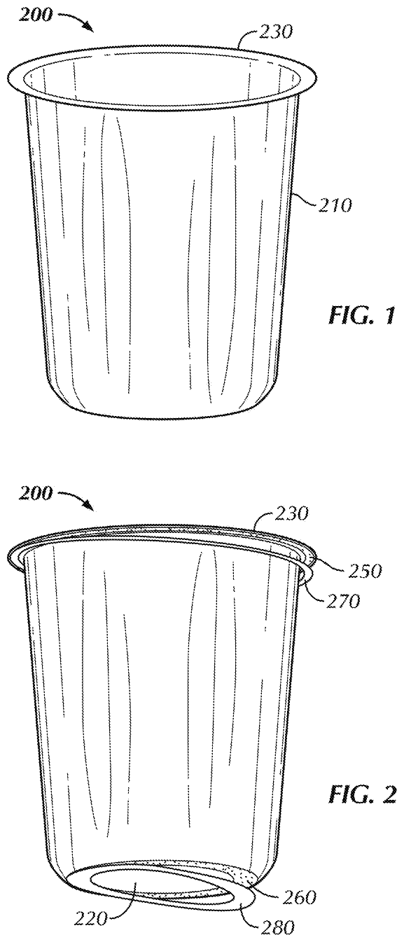

FIG. 1 shows a liner in accordance with an exemplary embodiment of the invention. The liner (200) comprises a cylindrical side wall (210) with a rim (230) extending radially outward from the upper end of the side wall (210).

The cylindrical side wall may slightly taper toward the lower end to allow the bottom (230, not indicated) to pass through the open center of the upper rim (230) for purposes of nesting or stacking a plurality of liners. One skilled in the arts would appreciate that the liner may be rigid, or may be flexible, and that the determination is a factor of the thickness, type of material, and manufacturing methods used to form the liner.

FIG. 2 shows a liner with adhesives and protective strips in accordance with an exemplary embodiment of the invention. The liner (200) comprises a cylindrical side wall (210, not indicated) with an upper rim (230) extending radially outward from the upper end of the side wall (210). The cylindrical side wall (210, not indicated) is enclosed at the lower end with a bottom (220).

A first adhesive material (260) is applied to the outside surface of the bottom (220) and covered with a removable protective cover (280) until ready for insertion in a bucket. In this embodiment the adhesive material (260) is applied in a ring configuration, and the protective cover (280) is also configured as a ring smaller than the circumference of the bottom (220). One skilled in the art would appreciate that the adhesive material (260) may be in any configuration on the bottom (220) and the protective cover (280) may be in another configuration, such as a circle, or any other configuration that covers and protects the adhesive material (260) until time of use.

A second adhesive material (250) is applied to the upper rim (230) and covered with a removable protective strip (270) until ready for use. In this embodiment the protective strip (270) is a ring around the outside of the cylindrical side wall (210, not indicated). One skilled in the art would appreciate that the protective strip (270) may be a curved ribbon, may include a tab for easy removal, or may be in any other configuration that covers and protects the adhesive material (250) until time of use.

The first adhesive material (260) and the second adhesive material (250) may be the same adhesive or may be different adhesives. The protective cover (280) and the protective strip (270) may be of any material that is removable to expose the adhesive materials (250 & 260) for use.

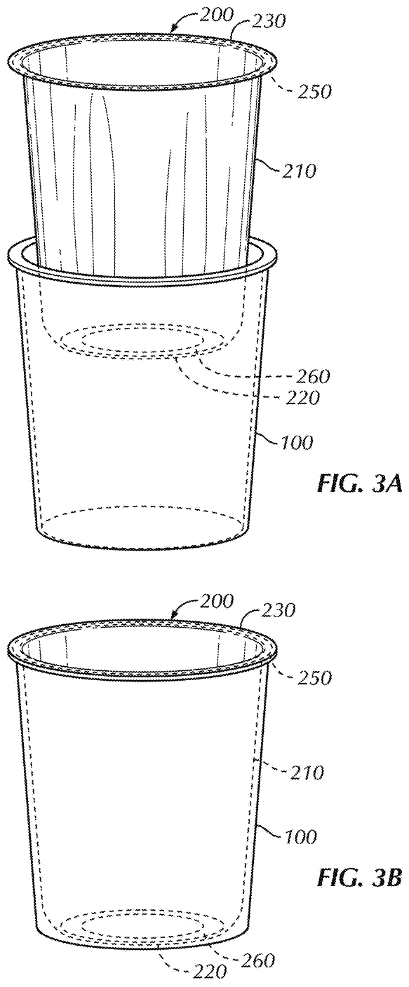

FIGS. 3A and 3B illustrate insertion of a liner into a bucket in accordance with an exemplary embodiment of the invention. A liner (200) is sized to fit a bucket (100) such that the liner's (200) bottom (220), side wall (210) and rim (230) all contact the bucket's (100) inner surfaces and top edge. Adhesive (250 & 260) is applied to the liner's bottom (220) and the liner's rim (230) so that the liner adheres to the bucket's surface when installed.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Some elements illustrated in one form could actually vary in detail. Specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A liner for a bucket, said liner comprising:
a cylindrically configured side wall,
a bottom enclosing the lower end of the side wall,
and a rim, said rim extending radially from the top end of the side wall, and
an adhesive on the outer surface of the liner.

2. A liner for a bucket as described in claim 1 further comprising:
a protective removable cover protecting the adhesive on the outer surface of the liner.

3. A liner for a bucket as described in claim 1 wherein the adhesive is on the outside bottom of the liner.

4. A liner for a bucket as described in claim 3 wherein the adhesive on the outside bottom of the liner has a protective removable cover protecting the adhesive until intended use.

5. A liner for a bucket as described in claim 1 wherein the adhesive is on the underside of the rim of the liner.

6. A liner for a bucket as described in claim 5 wherein the adhesive on the underside of the rim of the liner has a protective removable cover protecting the adhesive until intended use.

7. A liner for a bucket as described in claim 1 wherein the side wall is tapered such that the liner is stackable.

8. A liner for a bucket as described in claim 1 wherein the liner is manufactured by injection molding of plastic material.

9. A liner for a bucket as described in claim 8 wherein the liner's plastic material has a working temperature in excess of 120° C.

10. A method of using a liner for a bucket, comprising:
taking a liner, said liner comprising:
a cylindrically configured side wall,
a bottom enclosing the lower end of the side wall,
and a rim, said rim extending radially from the top end of the side wall,
an adhesive on the outer surface of the bottom, with a removable cover, and
an adhesive on the underside of the rim, with a removable strip;
removing the removable cover on the adhesive on the bottom;
inserting the liner into a bucket;
adhering the adhesive to the bottom of the bucket;
removing substantially all air from between the inner bucket surface and the liner;
removing the removable cover from the rim; and
adhering the adhesive and rim to the top edge of the bucket.
